(19) United States
(12) Patent Application Publication
(10) Pub. No.: US 2015/0237567 A1
(43) Pub. Date: Aug. 20, 2015

(54) MOBILE HOTSPOT DEVICE AND METHOD FOR ACCESSING NETWORK

(71) Applicant: ZTE CORPORATION, Shenzhen, Guangdong (CN)

(72) Inventors: Rong Xue, Shenzhen (CN); Jianhua Zhang, Shenzhen (CN)

(21) Appl. No.: 14/422,420

(22) PCT Filed: Aug. 12, 2013
(86) PCT No.: PCT/CN2013/081324

§ 371 Date: Feb. 19, 2015

(30) Foreign Application Priority Data
Aug. 20, 2012 (CN) 201210296555.6

(51) Int. Cl. H04W 48/16

(52) U.S. Cl. CPC H04W 48/16; H04W 88/10

(57) ABSTRACT

A mobile hotspot device and a method for accessing a network are provided. The mobile hotspot device includes: an interface module, which is configured to provide a power interface and data communication; and a wireless communication module, which is coupled with the interface module, and configured to provide a network access mode corresponding to the power interface and control a terminal to access a network according to a current network access mode. The solution effectively buckles two independent products together, i.e. the interface module and the wireless communication module, thereby maintaining the small volume of conventional handheld terminals, facilitating to carry. In addition, the solution supports various interface modes, and supports Local Area Network (LAN) wired access, Wide Area Network (WAN) wireless access and Wireless Fidelity (WiFi) LAN coverage functionally, which provides various flexible network access modes for users. The solution meets requirements for portability and miniaturization, has relatively high universality, and is simple and feasible.

### TECHNICAL FIELD

The disclosure relates to the field of communications, and in particular to a mobile hotspot device and a method for accessing a network.

### BACKGROUND

With the continuous development of society and the continuous progress of science, people have not been limited to a place indoor or a fixed place to work, but often need to access a network anytime and anywhere. In addition, for many young people without housing, a fixed way of accessing a network will cause inconvenience.

Thus, these original ways, like accessing a network through an Ethernet interface, or accessing a network through a wireless local area network card which is inserted in a Universal Serial Bus (USB) interface of computer, have been difficult to meet the requirements of people for flexibility and portability.

### SUMMARY

The embodiments of the disclosure provide a mobile hotspot device and a method for accessing a network, so as to solve the problem that the network access mode in related technologies is difficult to meet the requirements of people for flexibility and portability.

According to an embodiment of the disclosure, a mobile hotspot device is provided. The mobile hotspot device includes: an interface module, which is configured to provide a power interface and data communication; and a wireless communication module, which is coupled with the interface module, and configured to provide a network access mode corresponding to the power interface and control a terminal to access a network according to a current network access mode.

In an example embodiment, the interface module includes: at least one interface and an interface control unit, wherein the interface control unit is coupled with the at least one interface, and configured to provide a data transmission channel between the at least one interface and the wireless communication module.

In an example embodiment, the at least one interface includes at least one of the followings: Alternate Current (AC) 220V power interface, adapter interface, Ethernet interface and USB interface.

In an example embodiment, the interface module further includes at least one of the followings: AC-Direct Current (DC) power conversion unit, which is coupled between the AC 220V power interface and the interface control unit, and configured to convert an AC 220V power into a DC power required by the wireless communication module; DC-DC power conversion unit, which is coupled between the adapter interface and the interface control unit, and configured to convert a DC power output by the adapter interface into the DC power required by the wireless communication module; Power Over Ethernet (POE) power supply unit, which is coupled between the Ethernet interface and the interface control unit, and configured to supply power for the wireless communication module over the Ethernet; Local Area Network (LAN)-USB signal conversion unit, which is coupled between the Ethernet interface and the interface control unit, and configured to utilize an LAN-USB protocol chip to convert an Ethernet interface signal into a USB signal; and USB interface unit, which is coupled between the USB interface and the interface control unit, and configured to provide the wireless communication module with the required DC power and USB communication.

In an example embodiment, the Ethernet interface is an RJ-45 cable interface.

In an example embodiment, the interface control unit includes: a determining subunit, which is configured to monitor an input voltage of the at least one interface, and determine a current interface mode; and a switch control subunit, which is configured to switch to an interface corresponding to the current interface mode.

In an example embodiment, the determining subunit is further configured to, when it is monitored that multiple interfaces have input voltage simultaneously, determine the current interface mode according to priorities of the multiple interfaces.

In an example embodiment, the interface control unit further includes: a USB hub, which is coupled with the LAN-USB signal conversion unit and the USB interface unit, and configured to allow, in a soft handoff mode, the LAN-USB signal conversion unit or the USB interface unit to communicate with the wireless communication module.

In an example embodiment, the wireless communication module includes: a USB interface, which is configured to provide the data transmission channel for the wireless communication module; and an application processor, which is configured to control the terminal to access a network in a network access mode corresponding to the current interface mode, wherein the network access mode at least includes one of the followings: accessing an LAN through a wired network interface, accessing a Wide Area Network (WAN) in a wireless mode, and Wireless Fidelity (WiFi) LAN coverage.

In an example embodiment, the wireless communication module further includes: a wireless unit, which is configured to provide a wireless network access: a WiFi unit, which is configured to provide the WiFi LAN coverage; and a power supply unit, which is configured to supply power to the application processor, the wireless unit and the WiFi unit for normal work.

According to another embodiment of the disclosure, a method for accessing a network, based on the above mobile hotspot device, is provided. The method for accessing a network includes: determining a current interface mode; and determining the current network access mode according to the current interface mode, and controlling a terminal to access a network according to the current network access mode.

In an example embodiment, determining the current interface mode includes: monitoring whether each interface has an input voltage; for the interface having an input voltage, determining the current interface mode according to a priority of the interface.

In an example embodiment, controlling the terminal to access the network according to the current network access mode includes: determining whether there is a terminal applying for access, and whether the number of terminals which have accessed is more than 0; if there is a terminal applying for access, and the number of the terminals which have accessed is more than 0, then determining whether the number of the terminals which have accessed is more than a maximum number of terminals which are allowed by the WiFi unit to access simultaneously; if there is no terminal applying for access, and there is no terminal which has accessed currently, the WiFi unit entering a standby state.

In an example embodiment, after determining whether the number of the terminals which have accessed is more than the maximum number of the terminals which are allowed by the WiFi unit to access simultaneously, the method further includes: if the number of the terminals which have accessed is not more than the maximum number of the terminals which are allowed to access simultaneously, then allowing the terminal to access the network.

In an example embodiment, after the WiFi unit enters the standby state, the method further includes: waking the WiFi unit up periodically, and polling whether there is a terminal applying for access.

The solution effectively buckles two independent products together, i.e. the interface module and the wireless communication module, thereby maintaining the small volume of conventional handheld terminals, facilitating to carry. In addition, the solution supports various interface modes, and supports Local Area Network (LAN) wired access, Wide Area Network (WAN) wireless access and Wireless Fidelity (WiFi) LAN coverage functionally, which provides various flexible network access modes for users. The solution meets requirements for portability and miniaturization, has relatively high universality, and is simple and feasible.

### BRIEF DESCRIPTION OF THE DRAWINGS

The accompanying drawings described here are used for providing a deeper understanding of the disclosure, and constitute a part of the application: schematic embodiments of the disclosure and description thereof are used for illustrating the disclosure and not intended to form improper limit to the disclosure. In the accompanying drawings:

FIG. 1 is a structural diagram of a mobile hotspot device according to an embodiment of the disclosure;

FIG. 2 is a flowchart of a method for accessing a network according to an embodiment of the disclosure;

FIG. 3a is a first structural diagram of a mobile hotspot device according to an example embodiment of the disclosure;

FIG. 3b is a second structural diagram of a mobile hotspot device according to an example embodiment of the disclosure;

FIG. 3c is an interface distribution diagram of a mobile hotspot device according to an example embodiment of the disclosure;

FIG. 4 is a structural diagram of a mobile hotspot device according to an example embodiment of the disclosure;

FIG. 5 is a structural diagram of an interface module according to an example embodiment of the disclosure;

FIG. 6 is a structural diagram of a POE power supply module according to an example embodiment of the disclosure;

FIG. 7 is a structural diagram of a DC/DC module according to an example embodiment of the disclosure;

FIG. 8 is a structural diagram of an interface control module according to an example embodiment of the disclosure;

FIG. 9 is a structural diagram of a wireless communication module according to an example embodiment of the disclosure;

FIG. 10 is a flowchart that a mobile hotspot device accesses, in a wireless mode, the WAN to work according to an example embodiment of the disclosure; and

FIG. 11 is a flowchart that a mobile hotspot device accesses, through an RJ-45 cable, the LAN to work according to an example embodiment of the disclosure.

### DETAILED DESCRIPTION OF THE EMBODIMENTS

Note that, embodiments and features in embodiments in the application can be combined with each other on condition of not conflicting. The disclosure is elaborated below with reference to the accompanying drawings and in combination with embodiments.

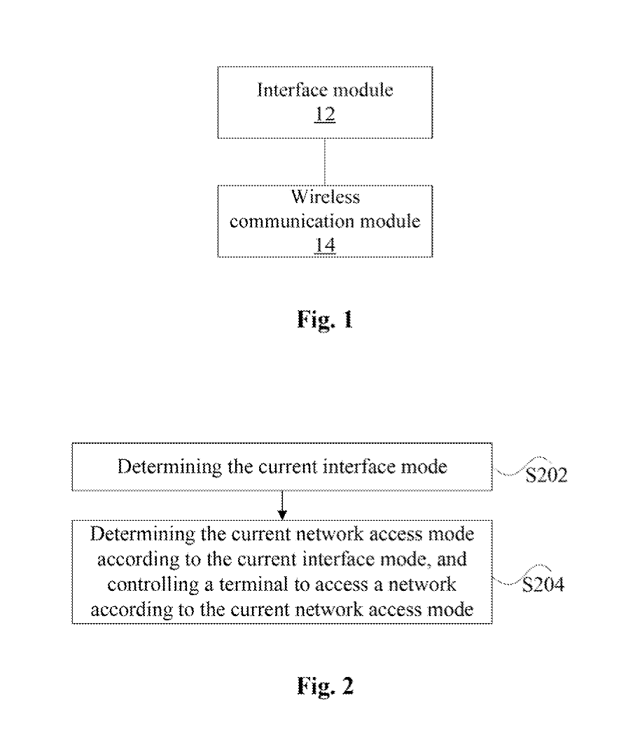

The disclosure provides a mobile hotspot device. FIG. 1 is a structural diagram of the mobile hotspot device according to an embodiment of the disclosure. As shown in FIG. 1, the mobile hotspot device includes an interface module 12 and a wireless communication module 14. The structure of the mobile hotspot device is elaborated below.

The interface module 12 is configured to provide a power interface and data communication; the wireless communication module 14 is coupled with the interface module 12, and configured to provide a network access mode corresponding to the power interface and control a terminal to access a network according to the current network access mode.

In related technologies, the network access mode is difficult to meet the requirements of people for flexibility and portability; for example, the original ways, like accessing a network through an Ethernet interface, or accessing a network through a wireless local area network card which is inserted in a USB interface of computer, are not flexible enough. The embodiment of the disclosure effectively buckles two independent products together, i.e. the interface module and the wireless communication module, thereby maintaining the small volume of conventional handheld terminals, facilitating to carry. In addition, the solution supports various interface modes, and supports Local Area Network (LAN) wired access, Wide Area Network (WAN) wireless access and Wireless Fidelity (WiFi) LAN coverage functionally, which provides various flexible network access modes for users. The solution meets requirements for portability and miniaturization, has relatively high universality, and is simple and feasible.

In an example embodiment, the interface module 12 includes: at least one interface and an interface control unit; wherein, the interface control unit is coupled with the at least one interface, and configured to provide a data transmission channel between the at least one interface and the wireless communication module 14. The at least one interface includes at least one of the followings: AC 220V power interface, adapter interface, Ethernet interface and USB interface. In an example embodiment, the Ethernet interface is an RJ-45 cable interface. The embodiment of the disclosure supports various interface modes, that is, any access of AC 220V, adapter, network interface and USB interface can be implemented anywhere.

Corresponding to the various interfaces, the interface module further includes at least one of the followings: AC-DC power conversion unit, which is coupled between the AC 220V power interface and the interface control unit, and configured to convert an AC 220V power into a DC power required by the wireless communication module 14; DC-DC power conversion unit, which is coupled between the adapter interface and the interface control unit, and configured to convert a DC power output by the adapter interface into the DC power required by the wireless communication module 14; POE power supply unit, which is coupled between the Ethernet interface and the interface control unit, and configured to supply power for the wireless communication module 14 over the Ethernet; LAN-USB signal conversion unit, which is coupled between the Ethernet interface and the interface control unit, and configured to utilize an LAN-USB protocol chip to convert an Ethernet interface signal into a USB signal; and USB interface unit, which is coupled between the USB interface and the interface control unit, and configured to provide the wireless communication module 14 with the required DC power and USB communication.

In an example embodiment, the interface control unit includes: a determining subunit, which is configured to monitor an input voltage of the at least one interface, and determine a current interface mode; and a switch control subunit, which is configured to switch to an interface corresponding to the current interface mode. In an example embodiment, the determining subunit is further configured to, when it is monitored that multiple interfaces have input voltage simultaneously, determine the current interface mode according to the priorities of the multiple interfaces.

The interface control unit further includes: a USB hub, which is coupled with the LAN-USB signal conversion unit and the USB interface unit, and configured to allow, in a soft handoff mode, the LAN-USB signal conversion unit or the USB interface unit to communicate with the wireless communication module 14.

The wireless communication module 14 includes: a USB interface, which is configured to provide a data transmission channel for the wireless communication module 14; and an application processor, which is configured to control the terminal to access a network in a network access mode corresponding to the current interface mode, wherein the network access mode at least includes one of the followings: accessing the LAN through a wired network interface, accessing the WAN in a wireless mode, and WiFi LAN coverage. Thus, the LAN wired access, the WAN wireless access and the WiFi LAN coverage are supported functionally, and various flexible network access modes are provided for users.

In an example embodiment, the wireless communication module 14 further includes: a wireless unit, which is configured to provide a wireless network access; a WiFi unit, which is configured to provide the WiFi LAN coverage; and a power supply unit, which is configured to supply power to the application processor, the wireless unit and the WiFi unit for normal work.

The embodiment of the disclosure also provides a method for accessing a network, which can be implemented based on the mobile hotspot device. FIG. 2 is a flowchart of the method for accessing a network according to an embodiment of the disclosure. As shown in FIG. 2, the method includes the following Step 202 to Step 204.

Step 202: Determining a current interface mode.

Step 204: Determining a current network access mode according to the current interface mode, and controlling a terminal to access a network according to the current network access mode.

In related technologies, the network access mode is difficult to meet the requirements of people for flexibility and portability: for example, the original ways, like accessing a network through an Ethernet interface, or accessing a network through a wireless local area network card which is inserted in a USB interface of computer, are not flexible enough. The embodiment of the disclosure effectively buckles two independent products together, i.e. the interface module and the wireless communication module, thereby maintaining the small volume of conventional handheld terminals, facilitating to carry. In addition, the solution supports various interface modes, and supports Local Area Network (LAN) wired access, Wide Area Network (WAN) wireless access and Wireless Fidelity (WiFi) LAN coverage functionally, which provides various flexible network access modes for users. The solution meets requirements for portability and miniaturization, has relatively high universality, and is simple and feasible.

Step 202 includes: monitoring whether each interface has an input voltage; for the interface having an input voltage, determining the current interface mode according to a priority of the interface.

Controlling a terminal to access a network according to the current network access mode includes: determining whether there is a terminal applying for access, and whether the number of the terminals which have accessed is more than 0; if there is a terminal applying for access, and the number of the terminals which have accessed is more than 0, then determining whether the number of the terminals which have accessed is more than the maximum number of the terminals which are allowed by the WiFi unit to access simultaneously; if there is no terminal applying for access, and there is no terminal which has accessed currently, the WiFi unit entering a standby state.

In an example embodiment, after determining whether the number of the terminals which have accessed is more than the maximum number of the terminals which are allowed by the WiFi unit to access simultaneously, the method further includes: if the number of the terminals which have accessed is not more than the maximum number of the terminals which are allowed to access simultaneously, then allowing the terminal to access the network.

In an example embodiment, after the WiFi unit enters the standby state, the method further includes: waking the WiFi unit up periodically, and polling whether there is a terminal applying for access.

To sum up, because the two independent products, i.e. the interface module and the wireless communication module are integrated, the mobile hotspot device of the embodiment of the disclosure requires no additional space structurally; the mobile hotspot device supports various interface modes, the AC 220V power interface, the adapter interface, the Ethernet interface and the USB interface, thus providing flexible selection for users; the mobile hotspot device supports the LAN wired access, the WAN wireless access and the WiFi LAN coverage functionally, thus providing various network access modes for users.

For making the technical solutions and the implementation method of the embodiments of the disclosure more clear, its implementation process is elaborated below with reference to the example embodiments.

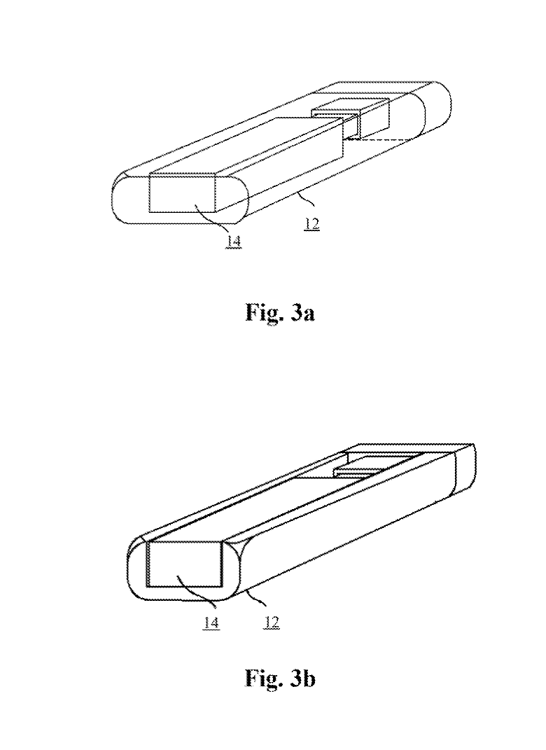

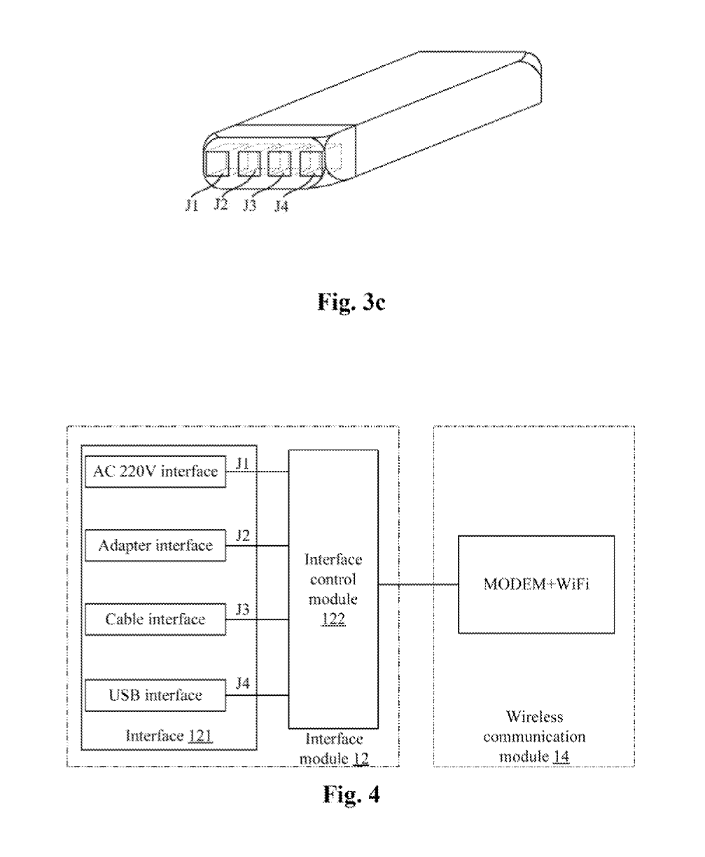

FIG. 3a is a first structural diagram of the mobile hotspot device according to an example embodiment of the disclosure. As shown in FIG. 3a, the wireless communication module 14 may be plugged on a front panel of the interface module 12, and then integrally buckled in the interface module; the wireless communication module 14 has a USB interface and may be plugged into the interface module 12, thus requiring no additional space.

FIG. 3b is a second structural diagram of the mobile hotspot device according to an example embodiment of the disclosure. As shown in FIG. 3b, the wireless communication module 14 is half encapsulated in the interface module 12.

FIG. 3c is an interface distribution diagram of the mobile hotspot device according to an example embodiment of the disclosure. As shown in FIG. 3c, the AC 220V power interface J1, the adapter interface J2, the Ethernet interface J3 and the USB interface J4 are distributed on the front panel of the interface module 12, and the back of the front panel is distributed with interface circuits and interface control modules corresponding to these interfaces. Note that, the distribution mode of the interfaces is not limited to such mode shown in FIG. 3c, but can be various: no matter which mode, provided the solution is accordant with the embodiment of the disclosure, the mode shall fall within the scope of the claims of the disclosure.

FIG. 4 is a structural diagram of the mobile hotspot device according to an example embodiment of the disclosure. As shown in FIG. 4, the mobile hotspot device includes the interface module 12 and the wireless communication module 14.

The interface module 12 provides the mobile hotspot device with any power interface and data communication, and includes at least one interface 121 and an interface control module 122. The interface module 12 supports the AC 220V power interface J1, the adapter interface J2, the Ethernet interface J3 (namely cable interface) and the USB interface J4 which are distributed on the front panel of the interface module 12. FIG. 3c shows an interface distribution mode as an example, but the four interfaces are not limited to such distribution mode. The interface control module 122 (implementing the function of the interface control unit) provides power and a data transmission channel between each interface and the wireless communication module 14; for the situation that several interfaces access simultaneously, the interface with the highest priority is selected to work.

The wireless communication module 14 can provide the LAN wired access, the WAN wireless access and the WiFi LAN coverage. The WAN wireless access can access a wireless network through the Global System for Mobile Communication (GSM), the Code Division Multiple Access (CDMA), the Wideband Code Division Multiple Access (WCDMA), the Long-Term Evolution (LTE) and any other wireless communication system. The WiFi LAN coverage is convenient for any wireless device of users to access. The wireless communication module 14 has the USB interface and may be plugged in an interface module M1, thus requiring no additional space. As shown in FIG. 3a and FIG. 3b, these two modes are only the embodiments of the disclosure, all the implementation modes which can couple the wireless communication module 14 and the interface module 12 together, and does not increase the volume of the device additionally shall fall within the scope of the claims of the disclosure. At the same time, the wireless communication module 14 may also be plugged into a computer directly or through a USB cable to work as an independent product.

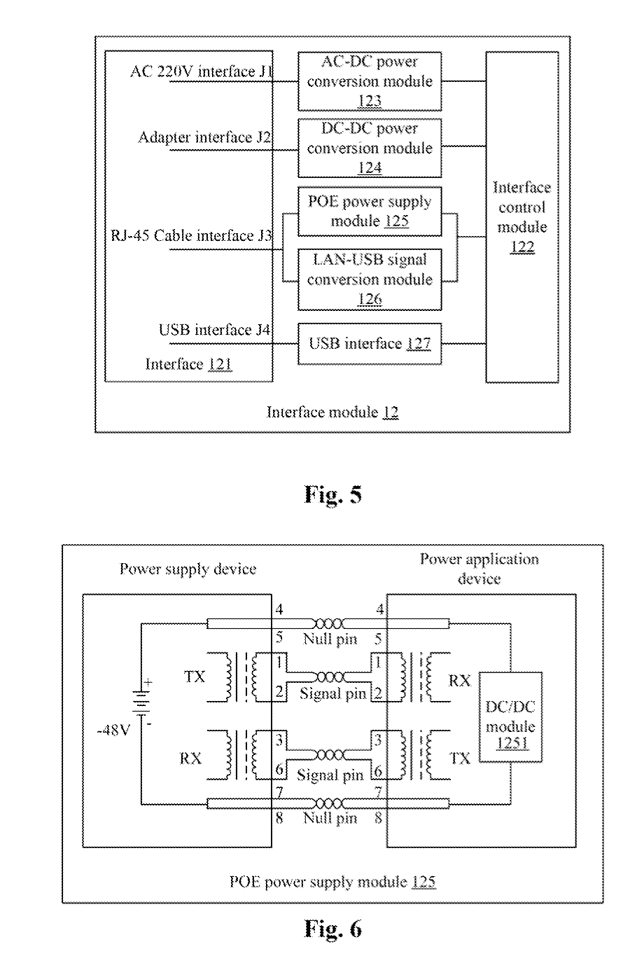

The interface module 12 and the wireless communication module 14 are elaborated below in combination with FIG. 5 to FIG. 9.

FIG. 5 is a structural diagram of the interface module according to an example embodiment of the disclosure. As shown in FIG. 5, the interface module 12 includes at least one interface 121, an interface control module 122, an AC-DC power conversion module 123, a DC-DC power conversion module 124, a POE power supply module 125, an LAN-USB signal conversion module 126 and a USB interface 127. These circuit modules are distributed on the back of the front panel of the interface module 12.

The AC-DC power conversion module 123 (implementing the function of the AC-DC power conversion unit) converts an AC 220V power into a DC power required by the wireless communication module 14 efficiently.

The DC-DC power conversion module 124 (implementing the function of the DC-DC power conversion unit) converts a DC power output by the adapter into a DC power required by the wireless communication module 14 efficiently.

The POE power supply module 125 (implementing the function of the POE power supply unit), wherein the POE means supplying power through the 10BASE-T Ethernet, the 100BASE-TX Ethernet and the 1000BASE-T Ethernet, and the longest distance of reliable power supply is 100 meters. The POE technology can ensure the normal operation of existing network while insuring the safety of existing structured cabling, and minimize the cost. The IEEE802.3af standard is a new standard based on the POE, increasing related standards of directly supplying power through the cable on the basis of IEEE802.3; it is an extension of the existing Ethernet standard, and is also the first international standard about power distribution. This standard specifies that the POE can provide power supply of 48V, 13 W.

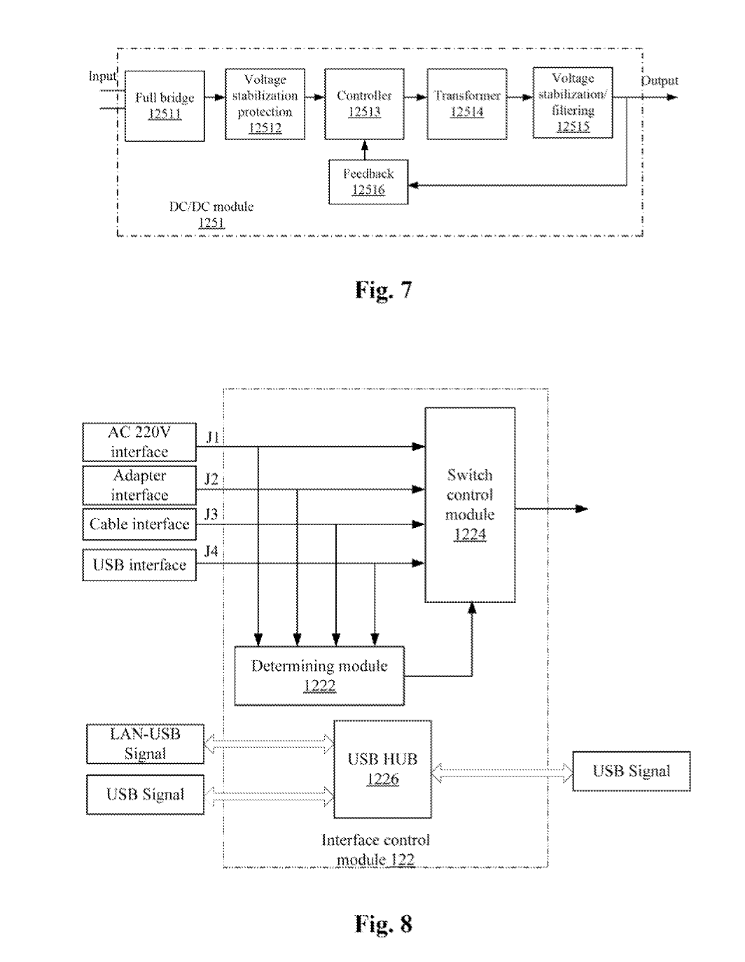

FIG. 6 is a structural diagram of the POE power supplying module according to an example embodiment of the disclosure. FIG. 6 is an embodiment of use allowed by the IEEE802.3af, but it is not limited to this mode. A functional structure of a DC/DC module 1251 is shown in FIG. 7. A full bridge 12511 allows power input from any direction; a voltage stabilization protection 12512 protects the DC/DC module 1251, avoiding damage caused by high voltage; a controller 12513 can convert an input power into a high-frequency square wave efficiently in a Pulse Width Modulation (PWM) mode; a transformer 12514 couples an AC square wave to an output end; after voltage stabilization/filtering 12515, the DC power required by the wireless communication module 14 can be output; a feedback 12516 feeds an output power back to the controller 12513, so that the controller 12513 follows up error to dynamically adjust in real time, which makes the output power more accurate.

The LAN-USB signal conversion module 126 (implementing the function of the LAN-USB signal conversion unit) utilizes the LAN-USB protocol chip to convert an RJ-45 network interface signal into a USB signal.

The USB interface 127 (implementing the function of the USB interface unit) can provide the mobile hotspot device with the DC power and USB communication required by the wireless communication module 14. FIG. 8 is a structural diagram of the interface control module according to an example embodiment of the disclosure. As shown in FIG. 8, the interface control module 122 includes a determining module 1222, a switch control module 1224 and a USB hub 1226.

The determining module 1222 (implementing the function of the determining subunit) determines an interface mode by monitoring the four interfaces J1 to J4, and controls the switch control module 1224 (implementing the function of the switch control subunit) to switch to the corresponding interface, thus ensuring the power and a data signal to reach the wireless communication module 14 reliably. For example, it is found by comparing through the determining module 1222 that the interface J1 has an input voltage, then the determining module 1222 controls the switch control module 1224 to switch to the interface J1, thus the power input from the AC 220V interface can be supplied to the wireless communication module 14 after conversion. For the situation that several interfaces access simultaneously, all the interfaces accessing are determined by the determining module 1222, and the switch control module 1224 is controlled to switch to the interface with the highest priority according to a certain priority order. The USB hub 1226, between the cable and the USB interface, allows them to communicate with the wireless communication module 14 in a soft handoff mode.

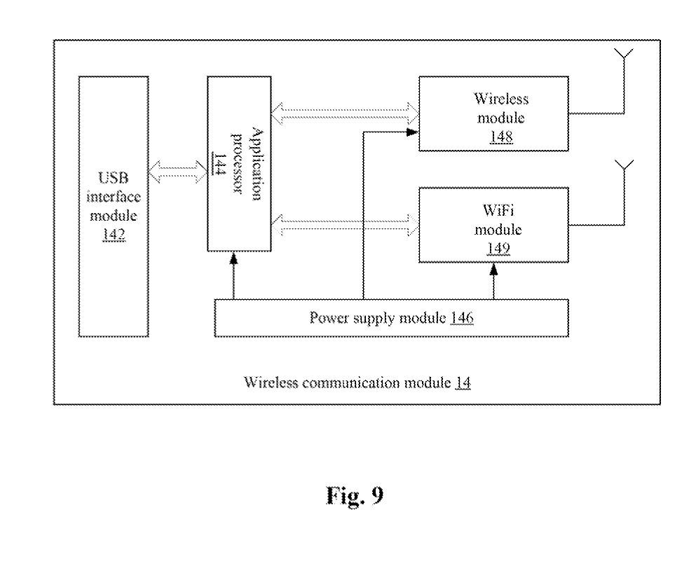

FIG. 9 is a structural diagram of the wireless communication module according to an example embodiment of the disclosure. As shown in FIG. 9, the wireless communication module 14 includes a USB interface module 142, an application processor 144, a power supply module 146, a wireless module 148 and a WiFi module 149.

The USB interface module 142 provides the data transmission channel for the wireless communication module 14, and can communicate with the interface module 12 or the computer directly.

The application processor 144 can control the wireless communication module 14 to access the LAN through a wired network interface, or access the WAN in a wireless mode. After the wireless communication module 14 accesses the WAN or the LAN, the WiFi module 149 is controlled through the application processor 144 to realize the WiFi LAN coverage.

The power supply module 146 (implementing the function of the power supply unit) supplies power to the wireless module 148 and the WiFi module 149 for normal work.

The wireless module 148 (implementing the function of the wireless unit) provides the wireless network access for users through the GSM, the CDMA, the WCDMA, the LTE and any other communication system.

The WiFi module 149 (implementing the function of the WiFi unit) provides Wireless Local Area Network (WLAN) coverage, and allows one or more wireless terminals to access simultaneously.

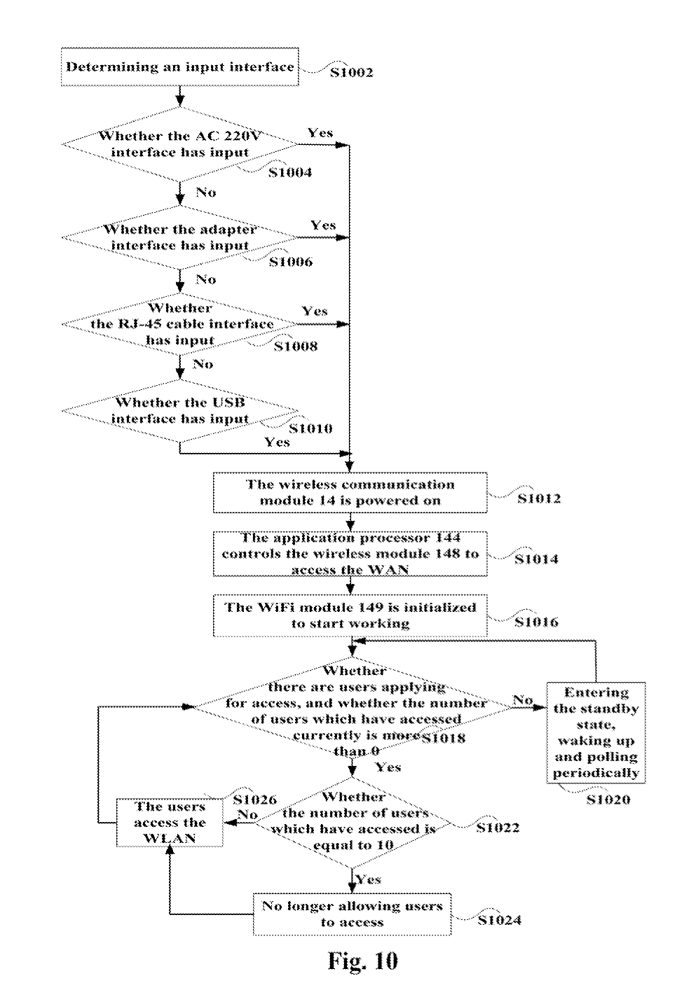

FIG. 10 is a flowchart that a mobile hotspot device accesses, in a wireless mode, a WAN to work according to an example embodiment of the disclosure. As shown in FIG. 10, the flow includes the following steps.

Step 1002: Determining an input interface.

Step 1004: Determining whether the AC 220V interface has input; if so, executing Step 1012; or else, executing Step 1006.

Step 1006: Determining whether the adapter interface has input; if so, executing Step 1012; or else, executing Step 1008.

Step 1008: Determining whether the RJ-45 cable interface has input; if so, executing Step 1012; or else, executing Step 1010.

Step 1010: Determining whether the USB interface has input; if so, executing Step 1012; or else, it is considered that there is no any interface inputting, and the subsequent operation is not performed.

Step 1012: The wireless communication module 14 is powered on to start working.

Step 1014: The application processor 144 controls the wireless module 148 to access the WAN through the GSM, the CDMA, the WCDMA, the LTE and any other communication system, so as to provide the wireless network access for users.

Step 1016: The application processor 144 initializes the WiFi module 149; the WiFi module 149 starts working to provide users with a WLAN network which is available to access.

Step 1018: The WiFi module 149 monitors whether there are users applying for access, and whether the number of users which have accessed currently is more than 0; if not, that is, there is no user accessing, and there is no user applying for access, executing Step 1020; if so, executing Step 1022.

Step 1020: The WiFi module 149 enters the standby state and can be waken up periodically; polling whether there are users applying for access.

Step 1022: The WiFi module 149 monitors whether the number of users which have accessed is equal to 10 (in the present example embodiment, suppose the maximum number of the users which are allowed by the WiFi unit to access simultaneously is 10), if it is less than 10, executing Step 1026; or else, executing Step 1024.

Step 1024: Allowing users to access the WLAN to work normally. After that, there will be users quitting, and there will also be users applying for access, so, turning to Step 1018 to circularly monitor whether there are users applying for access.

Step 1026: No longer allowing users to access; during this period, there will be users quitting, and there may be users applying for access, turning to Step 1018 to circularly determine.

Note that, in Step 1004 to Step 1010, the interface control module 122 determines the interfaces inputting according to the priority order, and controls the switch control module 1224 to switch to the corresponding interface, thus ensuring the power and the data signal to reach the wireless communication module 14 reliably. There is no sequence to determine whether each interface has input, and FIG. 10 is only an example diagram.

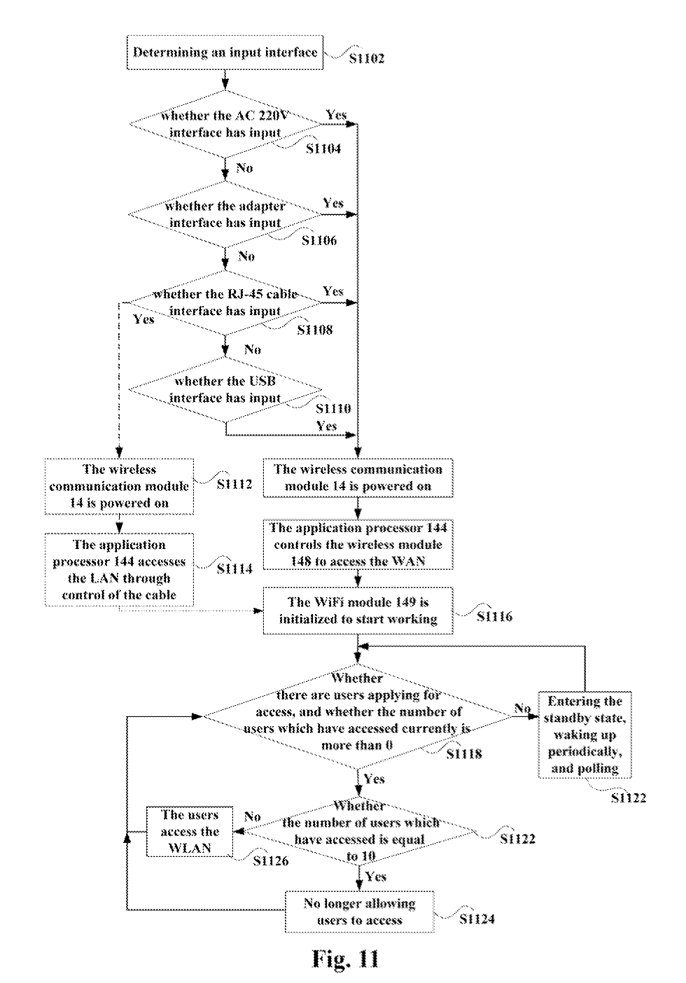

FIG. 11 is a flowchart that a mobile hotspot device accesses, through an RJ-45 cable, the LAN to work according to an example embodiment of the disclosure. As shown in the dotted portion of FIG. 11, the flow includes the following steps.

The steps from Step 1102 to Step 1112 are basically the same as the steps from Step 1002 to Step 1012, so they will not be repeated here. As shown in the dotted portion of FIG. 11, in the present example embodiment, the interface control module 122 determines that it is the Ethernet interface J3 inputting, and controls the switch control module 1224 to switch to the Ethernet interface; the power through the POE power supply module 125, and the signal through the LAN-USB signal conversion module 126 reach the wireless communication module 14 reliably.

Step 1114: The application processor 144 accesses the LAN through control of the cable.

The steps from Step 1116 to Step 1126 are the same as the steps from Step 1016 to Step 1026, so they will not be repeated here.

Note that, these steps presented in the flowchart of the accompanying drawings can be executed in a computer system like a group of machine-executable instructions; besides, although a logical sequence is shown in the flowchart, in some cases, the presented or described steps can be executed in an order different from that described here.

To sum up, according to the embodiments of the disclosure, a mobile hotspot device and a method for accessing a network are provided. The solution of the embodiments of the disclosure effectively buckles two independent products together, i.e. the interface module and the wireless communication module, thereby maintaining the small volume of conventional handheld terminals, facilitating to carry. In addition, the solution supports various interface modes, and supports Local Area Network (LAN) wired access, Wide Area Network (WAN) wireless access and Wireless Fidelity (WiFi) LAN coverage functionally, which provides various flexible network access modes for users. The solution meets requirements for portability and miniaturization, has relatively high universality, and is simple and feasible.

Obviously, those skilled in the art should appreciate that the above modules and steps of the disclosure can be implemented by a general-purpose computing device, and they can be centralized in a single computing device or distributed on a network composed of multiple computing devices; optionally, they can be implemented by program code which is capable of being executed by the computing device, so that they can be stored in a storage device and executed by the computing device, or they are made into integrated circuit modules, respectively, or multiple modules and steps of them are made into a single integrated circuit module to implement. In this way, the disclosure is not limited to any particular combination of hardware and software,

The above is only the example embodiment of the disclosure and not intended to limit the disclosure; for the skilled personnel in the field, the disclosure may have various modifications and changes. Any modifications, equivalent replacements, improvements and the like within the principle of the disclosure shall fall within the scope of the claims of the disclosure.

What is claimed is:

1. A mobile hotspot device, comprising:
an interface module, which is configured to provide a power interface and data Communication; and
a wireless communication module, which is coupled with the interface module, and configured to provide a network access mode corresponding to the power interface and control a terminal to access a network according to a current network access mode.

2. The mobile hotspot device according to claim 1, wherein the interface module comprises: at least one interface and an interface control unit, wherein the interface control unit is coupled with the at least one interface, and configured to provide a data transmission channel between the at least one interface and the wireless communication module.

3. The mobile hotspot device according to claim 2, wherein the at least one interface comprises at least one of the followings: Alternate Current (AC) 220V power interface, adapter interface, Ethernet interface and Universal Serial Bus (USB) interface.

4. The mobile hotspot device according to claim 3, wherein the interface module further comprises at least one of the followings:
AC-Direct Current (DC) power conversion unit, which is coupled between the AC 220V power interface and the interface control unit, and configured to convert an AC 220V power into a DC power required by the wireless communication module;
DC-DC power conversion unit, which is coupled between the adapter interface and the interface control unit, and configured to convert a DC power output by the adapter interface into the DC power required by the wireless communication module;
Power Over Ethernet (POE) power supply unit, which is coupled between the Ethernet interface and the interface control unit, and configured to supply power for the wireless communication module over the Ethernet;
Local Area Network (LAN)-USB signal conversion unit, which is coupled between the Ethernet interface and the interface control unit, and configured to utilize an LAN-USB protocol chip to convert an Ethernet interface signal into a USB signal; and
USB interface unit, which is coupled between the USB interface and the interface control unit, and configured to provide the wireless communication module with the required DC power and USB communication.

5. The mobile hotspot device according to claim 3 or 4 wherein the Ethernet interface is an RJ-45 cable interface.

6. The mobile hotspot device according to claim 2, wherein the interface control unit comprises:
a determining subunit, which is configured to monitor an input voltage of the at least one interface, and determine a current interface mode; and
a switch control subunit, which is configured to switch to an interface corresponding to the current interface mode.

7. The mobile hotspot device according to claim 6, wherein the determining subunit is further configured to, when it is monitored that multiple interfaces have input voltage simultaneously, determine the current interface mode according to priorities of the multiple interfaces.

8. The mobile hotspot device according to claim 6, wherein the interface control unit further comprises:
a USB hub, which is coupled with the LAN-USB signal conversion unit and the USB interface unit, and configured to allow, in a soft handoff mode, the LAN-USB signal conversion unit or the USB interface unit to communicate with the wireless communication module.

9. The mobile hotspot device according to claim wherein the wireless communication module comprises:
a USB interface, which is configured to provide a data transmission channel for the wireless communication module; and
an application processor, which is configured to control the terminal to access a network in a network access mode corresponding to the current interface mode, wherein the network access mode at least comprises one of the followings: accessing an LAN through a wired network interface, accessing a Wide Area Network (WAN) in a wireless mode, and Wireless Fidelity (WiFi) LAN coverage.

10. The mobile hotspot device according to claim 9, wherein the wireless communication module further comprises:
a wireless unit, which is configured to provide a wireless network access;
a WiFi unit, which is configured to provide the WiFi LAN coverage; and
a power supply unit, which is configured to supply power to the application processor, the wireless unit and the WiFi unit for normal work.

11. A method for accessing a network, wherein the method is based on a mobile hotspot device according to any one of claims 1 to 10, and the method comprises:
determining a current interface mode; and
determining the current network access mode according to the current interface mode, and controlling a terminal to access a network according to the current network access mode.

12. The method according to claim 11, wherein determining the current interface mode comprises:
monitoring whether each interface has an input voltage;
for the interface having an input voltage, determining the current interface mode according to a priority of the interface.

13. The method according to claim 11, wherein controlling the terminal to access the network according to the current network access mode comprises:
determining whether there is a terminal applying for access, and whether the number of terminals which have accessed is more than 0;
if there is a terminal applying for access, and the number of the terminals which have accessed is more than 0, then determining whether the number of the terminals which have accessed is more than a maximum number of terminals which are allowed by a Wireless Fidelity (WiFi) unit to access simultaneously;
if there is no terminal applying for access, and there is no terminal which has accessed currently, the WiFi unit entering a standby state.

14. The method according to claim 13, wherein after determining whether the number of the terminals which have accessed is more than the maximum number of the terminals which are allowed by the WiFi unit to access simultaneously, the method further comprises:
if the number of the terminals which have accessed is not more than the maximum number of the terminals which are allowed by the WiFi unit to access simultaneously, then allowing the terminal to access the network.

15. The method according to claim 13, wherein after the WiFi unit enters the standby state, the method further comprises:
waking the WiFi unit up periodically, and polling whether here is a terminal applying for access.
